(19) United States
(12) Patent Application Publication
(10) Pub. No.: US 2021/0073945 A1
(43) Pub. Date: Mar. 11, 2021

(54) METHOD AND APPARATUS FOR ENHANCING IMAGE RESOLUTION

(71) Applicant: LG Electronics Inc., Seoul (KR)

(72) Inventors: Young Kwon KIM, Seoul (KR); Seung Hwan MOON, Gyeonggi-do (KR); Keum Sung HWANG, Seoul (KR); Hyun Dae CHOI, Seoul (KR)

(21) Appl. No.: 16/773,443

(22) Filed: Jan. 27, 2020

(30) Foreign Application Priority Data
Sep. 11, 2019 (KR) 10-2019-0112608

(51) Int. Cl. G06T 3/40; G06F 3/0484; G06N 3/04; G06N 3/08

(52) U.S. Cl. CPC G06T 3/4046; G06T 3/4053; G06N 3/08; G06N 3/0454; G06F 3/04845

(57) ABSTRACT

A method for enhancing image resolution according to an embodiment of the present disclosure may include receiving a low resolution image, selecting an image processing area for the low resolution image, selecting a neural network for image processing according to an attribute of the selected area among neural network groups for image processing, and generating a high resolution image for the area by processing the selected image processing area according to the selected neural network for image processing. The neural network for image processing of the present disclosure may be a deep neural network generated through machine learning, and input and output of an image may be performed in an IoT environment using a 5G network.

### CROSS-REFERENCE TO RELATED APPLICATION

This application claims benefit of priority to Korean Patent Application No. 10-2019-0112608, filed on Sep. 11, 2019, the entire disclosure of which is incorporated herein by reference.

### BACKGROUND

### 1. Technical Field

The present disclosure relates to a method and apparatus for enhancing image resolution. More particularly, the present disclosure relates to a method and apparatus for generating a high-resolution image by analyzing an attribute of a low-resolution image and using a neural network for image processing suitable for the attribute, for super resolution imaging.

### 2. Description of Related Art

An image processing technology is a technology for performing specific operations on images to improve quality of the images or to extract specific information from the images.

The image processing technology is a technology that can be widely used in various fields and is one of the core technologies essentially required in various fields such as an autonomous driving vehicle, a security monitoring system, video communication, and high-definition image transmission.

With the development of high-resolution image sensors, 5G communication networks, and artificial intelligence technologies, the image processing technology is under development. Recently, a method for converting a low-resolution image into a high-resolution image using a deep neural network has been attempted.

U.S. Patent Publication No. 2018-0300855 relates to a “method and system for image processing,” and discloses a technology of arbitrarily cropping high resolution original images to generate a training image for training a neural network, setting the cropped high resolution original images to be ground truth images, blurring each of the ground truth images, generating a low resolution image through down sampling, and paring the ground truth images with the low resolution image.

The above-described document discloses a method for automatically generating training data for training a neural network for enhancing image resolution but does not disclose a method for effectively utilizing the generated neural network.

U.S. Patent Publication No. 2019-0096032 relates to a “deep neural network for image enhancement”, and discloses a method for generating a high resolution image from a low resolution image by receiving a low resolution image having a first size, determining an interpolated image of a low resolution image having a second size larger than the first size, and determining a high resolution image using the interpolated image and deep neural network model data.

The above-mentioned document discloses a method for generating a high resolution image using an interpolated image from a deep neural network model and a low resolution image, but has a disadvantage of making resolution enhancement performance different and changing a processing speed depending on what type of images are input by using the deep neural network model trained in one way regardless of a type of images.

In order to overcome the disadvantages described above, there is a need for a solution capable of effectively generating a high-resolution image by utilizing a neural network model trained in various ways on various types of images in the most suitable way.

On the other hand, the above-mentioned prior art is technical information that the inventors possess for deriving the present disclosure or acquired in the process of deriving the present disclosure, and thus should not be construed as art that was publicly known prior to the filing date of the present disclosure.

### SUMMARY OF THE INVENTION

An aspect of the present disclosure is to solve a problem in that performance varies depending on a type of target images by performing resolution enhancement processing on all types of images using one neural network determined in the prior art.

In addition, an aspect of the present disclosure is to solve the problem in that image processing is not efficiently performed by performing the resolution enhancement processing on the whole part of an image using one neural network determined in the prior art.

In addition, an aspect of the present disclosure is to solve a problem in that that unnecessary waste of computing power is caused, and the overall image processing speed is reduced by enhancing resolution for the overall image regardless of a user's interest in the prior art.

In addition, an aspect of the present disclosure is to solve the problem in that a sufficiently high quality of images does not show even if there is room for processing power and processing time by using the same image resolution enhancement method regardless of a user's region of interest in an image in the prior art.

In addition, an aspect of the present disclosure is to solve the problem in that an effective and efficient method suitable for a user's request is not used by using a method for constantly enhancing image resolution regardless of a zoom level requested by a user in the prior art.

An embodiment of the present disclosure may provide a method and apparatus for enhancing image resolution that outputs an optimal high resolution image result by identifying an image attribute of a low resolution image and selecting a neural network for image processing trained with images having the attribute among a plurality of neural networks for image processing to improve resolution.

Another embodiment of the present disclosure may provide a method and apparatus for enhancing image resolution that predicts a result region to be displayed according to an enlargement or reduction instruction for a low resolution image, selects an appropriate neural network for image processing depending on a zoom level according to the enlargement or reduction instruction, and applies the selected neural network to the result region to be displayed.

Another embodiment of the present disclosure may provide a method and apparatus for enhancing image resolution that identifies an object included in a low resolution image, determines a type of the object, applies a neural network trained to enhance image resolution for the type of the object to output an optimal high resolution image result.

A method for enhancing image resolution according to an embodiment of the present disclosure may include receiving a low resolution image, selecting an image processing area for the low resolution image, selecting a neural network for image processing according to an attribute of the selected area among neural network groups for image processing, and generating a high resolution image for the area by processing the selected image processing area according to the selected neural network for image processing.

The selecting of the image processing area may include identifying an object included in the low-resolution image through a neural network for object recognition; selecting an image area including the identified object; and determining an attribute of the selected image area according to a type of the identified object.

The type of the object may be at least one of a person, text, and a logo, and the neural network group for image processing may include at least one of a neural network trained to enhance a resolution of a person image, a neural network trained to enhance a resolution of a text image, and a neural network trained to enhance a resolution of a logo image.

The selecting of the neural network for image processing may include selecting a neural network for image processing suitable for the type of the identified object among the neural network groups for image processing.

In addition, in the method for enhancing image resolution according to an embodiment of the present disclosure, the selecting of the image processing area may include: receiving a screen enlargement or reduction instruction from a user; selecting an image area to be displayed according to the screen enlargement or reduction instruction; and determining the attribute of the selected image area according to the screen enlargement or reduction magnification.

Here, the selecting of the neural network for image processing may include selecting a neural network for image processing having higher complexity among the neural network groups for image processing as a zoom magnification according to the screen enlargement or reduction instruction increases.

Further, in the method for enhancing image resolution according to an embodiment of the present disclosure, the selecting of the image processing area may include receiving a screen enlargement or reduction instruction from a user, and the selecting of the neural network for image processing may include selecting a first neural network from the neural network group for image processing in response to receiving the enlargement instruction from the user, and selecting a second neural network from the neural network group for image processing in response to receiving the reduction instruction from the user.

Here, the complexity of the first neural network may be higher than that of the second neural network.

In the method for enhancing image resolution according to an embodiment of the present disclosure, the low resolution image may be a multi-frame image, and the processing of the selected image processing area may include acquiring a high resolution image through the selected neural network for image processing by using the multi-frame image as an input.

Further, the method for enhancing image resolution according to an embodiment of the present disclosure may further include after the generating of the high-resolution image, generating a synthesis image by synthesizing the low-resolution image with the high-resolution image for the area.

A method for enhancing image resolution according to another embodiment of the present disclosure may include receiving a low resolution image; receiving an enlargement or reduction instruction from a user; selecting an area to be displayed in the low resolution image according to the enlargement or reduction instruction; and selecting a first neural network for image processing according to the enlargement or reduction instruction and applying the first neural network for image processing to the image of the area to be displayed.

The method for enhancing image resolution according to another embodiment of the present disclosure may further include: after the selecting of the area to be displayed, identifying an object within the image of the area to be displayed by using a neural network for object identification; selecting a second neural network for image processing according to a type of the identified object and applying the selected second neural network for image processing to an image including the object; and generating a high resolution image of the image including the object through the second neural network for image processing.

The method for enhancing image resolution according to another embodiment of the present disclosure may further include: after the receiving of the low resolution image, generating an image having enhanced resolution by applying a third neural network for image processing to the low resolution image, in which the applying to the image may include applying the first neural network for image processing to the enhanced image.

The method for enhancing image resolution according to another embodiment of the present disclosure may further include after the generating of the high-resolution image of the object, generating a synthesis image by synthesizing the enhanced image with the high-resolution image for the object.

The second neural network for image processing may be a neural network for image processing trained to enhance a resolution of an image belonging to the type of the object.

The second neural network for image processing may be a neural network trained with training data including a plurality of low-resolution images belonging to the type of the object as input data and high-resolution images corresponding to the low-resolution images as a label.

In the method for enhancing image resolution according to another embodiment of the present disclosure, the applying to the image of the area to be displayed may include selecting a neural network for image processing having high complexity as the first neural network for image processing as a zoom magnification according to the enlargement or reduction instruction increases.

In the method for enhancing image resolution according to another embodiment of the present disclosure, the receiving of the enlargement or reduction instruction from the user may include receiving an enlargement or reduction instruction according to a pinch movement of the user, and the applying to the image may include selecting a first neural network for image processing based on a moving distance and direction of the pinch movement.

When the direction of the pinch movement is a pinch-in direction, the neural network for image processing having high complexity may be selected as the first neural network for image processing as the moving distance increases, and when the direction of the pinch movement is a pinch-out direction, the neural network for image processing having low complexity may be selected as the first neural network for image processing as the moving distance increases.

The method for enhancing image resolution according to another embodiment of the present disclosure may further include: after the selecting of the area to be displayed and before the applying to the image, identifying an object within the image of the area to be displayed by using a neural network for object identification; and selecting a neural network group for image processing suitable for the type of the object according to the type of the identified object.

The first neural network for image processing may be one of the neural networks for image processing belonging to the neural network group for image processing.

A computer-readable recording medium for enhancing image resolution according to an embodiment of the present disclosure may be a computer-readable recording medium in which a computer program for executing any one of the above-described methods is stored.

An apparatus for enhancing image resolution according to an embodiment of the present disclosure may include: a processor; and a memory connected to the processor, in which the memory stores instructions to cause the processor to receive a low resolution image, receive an enlargement or reduction instruction from a user, select an area to be displayed in the low resolution image according to the enlargement or reduction instruction, and select a first neural network for image processing according to the enlargement or reduction instruction and apply the first neural network for image processing to an image of the area to be displayed when executed by the processor.

The instructions may cause the processor to identify an object in the image of the area to be displayed using a neural network for object identification, select a second neural network for image processing according to a type of the identified object and apply the select second neural network for image processing to the image including the object, and generate a high resolution image of the image including the object through the second neural network for image processing.

The instructions may cause the processor to identify the object in the image of the area to be displayed using a neural network for object identification, select the neural network group for image processing suitable for the type of the object according to the type of the identified object, and select one of the neural networks for image processing belonging to the neural network group for image processing as the first neural network for image processing according to the enlargement or reduction instruction.

The above-mentioned aspects, features, and advantages and other aspects, features, and advantages will become obvious from the following drawings, claims, and detailed description of the present disclosure.

The apparatus and method for enhancing image resolution according to the embodiment of the present disclosure can acquire the optimal high-resolution image for each image by selecting and using the neural network for image processing suitable for the attribute of the image.

In addition, according to the embodiment of the present disclosure, it is possible to perform the image processing on the object of the image in the most effective manner by identifying the object included in the image and select and use the neural network for image processing suitable for the type of the identified object.

In addition, according to the embodiment of the present disclosure, it is possible to provide the image information necessary for the user in an efficient manner by identifying the object that the user is expected to be interested in and preferentially enhancing the resolution for the corresponding object.

In addition, according to the embodiment of the present disclosure, it is possible to prevent the unnecessary waste of computing power and improve the overall image processing speed by performing the image processing on the area to be displayed by the user.

In addition, according to the embodiment of the present disclosure, it is possible to display the highest quality of images at the given processing power and processing time by using the method for enhancing image resolution suitable for the region of interest of the user.

In addition, according to the embodiment of the present disclosure, it is possible to use the method for effectively and efficiently enhancing resolution suitable for the user's request by using the method for enhancing image resolution suitable for the zoom level requested by the user.

The effects of the present disclosure are not limited to those mentioned above, and other effects not mentioned can be clearly understood by those skilled in the art from the following description.

### BRIEF DESCRIPTION OF THE DRAWINGS

The above and other aspects, features, and advantages of the present disclosure will become apparent from the detailed description of the following aspects in conjunction with the accompanying drawings, in which:

FIG. 1 is an exemplary diagram of an environment for performing a method for enhancing image resolution according to an embodiment of the present disclosure;

FIG. 2 is a diagram illustrating a system for generating a neural network for image processing according to an embodiment of the present disclosure;

FIG. 3 is a diagram for describing a neural network for image processing according to an embodiment of the present disclosure;

FIG. 4 is a diagram for describing a method for enhancing image resolution according to an embodiment of the present disclosure;

FIG. 5 is a flowchart for describing a method for enhancing image resolution for each object according to an embodiment of the present disclosure;

FIG. 6 is a diagram for describing a process of performing, by a user terminal, a method for enhancing image resolution according to an embodiment of the present disclosure;

FIG. 7 is a flowchart for describing a method for enhancing image resolution for each zoom level according to an embodiment of the present disclosure;

FIG. 8 is a diagram for describing a method for enhancing image resolution in a zoom-in operation according to an embodiment of the present disclosure;

FIG. 9 is a diagram for describing a method for enhancing image resolution in a zoom-out operation according to an embodiment of the present disclosure; and

FIG. 10 is a flowchart for describing a method for enhancing image resolution according to an embodiment of the present disclosure.

### DETAILED DESCRIPTION

The advantages and features of the present disclosure and ways to achieve them will be apparent by making reference to embodiments as described below in detail in conjunction with the accompanying drawings. However, it should be construed that the present disclosure is not limited to the embodiments disclosed below but may be implemented in various different forms, and covers all the modifications, equivalents, and substitutions belonging to the spirit and technical scope of the present disclosure. The embodiments disclosed below are provided so that this disclosure will be thorough and complete and will fully convey the scope of the present disclosure to those skilled in the art. Further, in the following description of the present disclosure, a detailed description of known technologies incorporated herein will be omitted when it may make the subject matter of the present disclosure rather unclear.

The terms used in this application is for the purpose of describing particular embodiments only and is not intended to limit the disclosure. As used herein, the singular forms are intended to include the plural forms as well, unless the context clearly indicates otherwise. The terms “comprises,” “comprising,” “includes,” “including,” “containing,” “has,” “having” or other variations thereof are inclusive and therefore specify the presence of stated features, integers, steps, operations, elements, and/or components, but do not preclude the presence or addition of one or more other features, integers, steps, operations, elements, components, and/or groups thereof. Furthermore, these terms such as “first,” “second,” and other numerical terms, are used only to distinguish one element from another element. These terms are generally only used to distinguish one element from another.

Hereinafter, embodiments of the present disclosure will be described in detail with reference to the accompanying drawings, and in the description with reference to the accompanying drawings, the same or corresponding components have the same reference numeral, and a duplicate description therefor will be omitted.

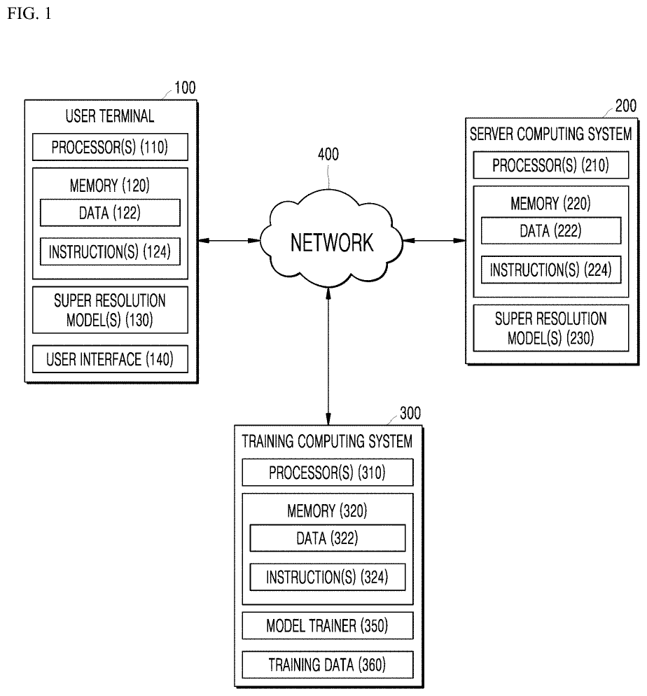

FIG. 1 is an exemplary diagram of an environment for performing a method for enhancing image resolution according to an embodiment of the present disclosure.

An environment for performing a method for enhancing image resolution according to an embodiment of the present disclosure includes a user terminal 100, a server computing system 200, a training computing system 300, and a network 400 that enables them to communicate with each other.

The user terminal 100 may support Internet of things (IoT), Internet of everything (IoE), Internet of small things (IoST), and the like, and support machine to machine (M2M) communication, device to device (D2D) communication and the like.

The user terminal 100 may determine a method for enhancing image resolution using big data, artificial intelligence (AI) algorithms, and/or machine learning algorithms in a 5G environment connected for the IoT.

The user terminal 100 may be, for example, any types of computing devices such as a personal computer, a smartphone, a tablet, a game console, and a wearable device. The user terminal 100 may include one or more processors 110 and a memory 120.

One or more processors 110 may include all types of devices capable of processing data, for example, an MCU. Here, ‘the processor’ may, for example, refer to a data processing device embedded in hardware, which has physically structured circuitry to perform a function represented by codes or instructions contained in a program.

As one example of the data processing device embedded in the hardware, a microprocessor, a central processor (CPU), a processor core, a multiprocessor, an application-specific integrated circuit (ASIC), a field programmable gate array (FPGA), and the like may be included, but the scope of the present disclosure is not limited thereto.

A memory 120 may include one or more non-transitory storage media such as RAM, ROM, EEPROM, EPROM, flash memory devices, and magnetic disks. The memory 120 may store instructions 124 that cause a user terminal 100 to perform operations when executed by data 122 and processors 110.

In addition, the user terminal 100 may include the user interface 140 to receive instructions from a user and transmit output information to the user. The user interface 140 may include various input means such as a keyboard, a mouse, a touch screen, a microphone, and a camera, and various output means such as a monitor, a speaker, and a display.

The user may select an area of an image to be processed in the user terminal 100 through the user interface 140. For example, a user may select a desired object or area in the low-resolution image that the resolution is to be enhanced by using a mouse, a keyboard, a touch screen, or the like. In addition, the user may generate a instruction to reduce or enlarge an image by performing a pinch-in or pinch-out operation on the touch screen.

In one embodiment, the user terminal 100 may also store or include super resolution models 130 to which the artificial intelligence technology is applied. For example, the super resolution models 130 to which the artificial intelligence technology is applied may be or include various learning models such as a deep neural network or other types of machine learning models.

Artificial intelligence (AI) is an area of computer engineering science and information technology that studies methods to make computers mimic intelligent human behaviors such as reasoning, learning, self-improving, and the like.

In addition, artificial intelligence does not exist on its own, but is rather directly or indirectly related to a number of other fields in computer science. In recent years, there have been numerous attempts to introduce an element of AI into various fields of information technology to solve problems in the respective fields.

Machine learning is an area of artificial intelligence that includes the field of study that gives computers the capability to learn without being explicitly programmed.

Specifically, the Machine Learning can be a technology for researching and constructing a system for learning, predicting, and improving its own performance based on empirical data and an algorithm for the same. The algorithms of the Machine Learning take a method of constructing a specific model in order to obtain the prediction or the determination based on the input data, rather than performing the strictly defined static program instructions.

Numerous machine learning algorithms have been developed for data classification in machine learning. Representative examples of such machine learning algorithms for data classification include a decision tree, a Bayesian network, a support vector machine (SVM), an artificial neural network (ANN), and so forth.

Decision tree refers to an analysis method that uses a tree-like graph or model of decision rules to perform classification and prediction.

Bayesian network may include a model that represents the probabilistic relationship (conditional independence) among a set of variables. Bayesian network may be appropriate for data mining via unsupervised learning.

SVM may include a supervised learning model for pattern detection and data analysis, heavily used in classification and regression analysis.

ANN is a data processing system modelled after the mechanism of biological neurons and interneuron connections, in which a number of neurons, referred to as nodes or processing elements, are interconnected in layers.

ANNs are models used in machine learning and may include statistical learning algorithms conceived from biological neural networks (particularly of the brain in the central nervous system of an animal) in machine learning and cognitive science.

ANNs may refer generally to models that have artificial neurons (nodes) forming a network through synaptic interconnections and acquires problem-solving capability as the strengths of synaptic interconnections are adjusted throughout training.

The terms ‘artificial neural network’ and ‘neural network’ may be used interchangeably herein.

An ANN may include a number of layers, each including a number of neurons. In addition, the Artificial Neural Network can include the synapse for connecting between neuron and neuron.

An ANN may be defined by the following three factors: (1) a connection pattern between neurons on different layers; (2) a learning process that updates synaptic weights; and (3) an activation function generating an output value from a weighted sum of inputs received from a lower layer.

ANNs include, but are not limited to, network models such as a deep neural network (DNN), a recurrent neural network (RNN), a bidirectional recurrent deep neural network (BRDNN), a multilayer perception (MLP), and a convolutional neural network (CNN).

An ANN may be classified as a single-layer neural network or a multi-layer neural network, based on the number of layers therein.

In general, a single-layer neural network may include an input layer and an output layer.

In general, a multi-layer neural network may include an input layer, one or more hidden layers, and an output layer.

The input layer receives data from an external source, and the number of neurons in the input layer is identical to the number of input variables. The hidden layer is located between the input layer and the output layer, and receives signals from the input layer, extracts features, and feeds the extracted features to the output layer. The output layer receives a signal from the hidden layer and outputs an output value based on the received signal. Input signals between the neurons are summed together after being multiplied by corresponding connection strengths (synaptic weights), and if this sum exceeds a threshold value of a corresponding neuron, the neuron can be activated and output an output value obtained through an activation function.

In the meantime, a deep neural network with a plurality of hidden layers between the input layer and the output layer may be the most representative type of artificial neural network which enables deep learning, which is one machine learning technique.

An ANN can be trained using training data. Here, the training may refer to the process of determining parameters of the artificial neural network by using the training data, to perform tasks such as classification, regression analysis, and clustering of inputted data. Such parameters of the artificial neural network may include synaptic weights and biases applied to neurons.

An artificial neural network trained using training data can classify or cluster inputted data according to a pattern within the inputted data.

Throughout the present specification, an artificial neural network trained using training data may be referred to as a trained model.

Hereinbelow, learning paradigms of an artificial neural network will be described in detail.

Learning paradigms, in which an artificial neural network operates, may be classified into supervised learning, unsupervised learning, semi-supervised learning, and reinforcement learning.

Supervised learning is a machine learning method that derives a single function from the training data.

Among the functions that may be thus derived, a function that outputs a continuous range of values may be referred to as a regressor, and a function that predicts and outputs the class of an input vector may be referred to as a classifier.

In supervised learning, an artificial neural network can be trained with training data that has been given a label.

Here, the label may refer to a target answer (or a result value) to be guessed by the artificial neural network when the training data is inputted to the artificial neural network.

Throughout the present specification, the target answer (or a result value) to be guessed by the artificial neural network when the training data is inputted may be referred to as a label or labeling data.

Throughout the present specification, assigning one or more labels to training data in order to train an artificial neural network may be referred to as labeling the training data with labeling data.

Training data and labels corresponding to the training data together may form a single training set, and as such, they may be inputted to an artificial neural network as a training set.

The training data may exhibit a number of features, and the training data being labeled with the labels may be interpreted as the features exhibited by the training data being labeled with the labels. In this case, the training data may represent a feature of an input object as a vector.

Using training data and labeling data together, the artificial neural network may derive a correlation function between the training data and the labeling data. Then, through evaluation of the function derived from the artificial neural network, a parameter of the artificial neural network may be determined (optimized).

Unsupervised learning is a machine learning method that learns from training data that has not been given a label.

More specifically, unsupervised learning may be a training scheme that trains an artificial neural network to discover a pattern within given training data and perform classification by using the discovered pattern, rather than by using a correlation between given training data and labels corresponding to the given training data.

Examples of unsupervised learning include, but are not limited to, clustering and independent component analysis.

Examples of artificial neural networks using unsupervised learning include, but are not limited to, a generative adversarial network (GAN) and an autoencoder (AE).

GAN is a machine learning method in which two different artificial intelligences, a generator and a discriminator, improve performance through competing with each other.

The generator may be a model generating new data that generates new data based on true data.

The discriminator may be a model recognizing patterns in data that determines whether inputted data is from the true data or from the new data generated by the generator.

Furthermore, the generator may receive and learn from data that has failed to fool the discriminator, while the discriminator may receive and learn from data that has succeeded in fooling the discriminator. Accordingly, the generator may evolve so as to fool the discriminator as effectively as possible, while the discriminator evolves so as to distinguish, as effectively as possible, between the true data and the data generated by the generator.

An auto-encoder (AE) is a neural network which aims to reconstruct its input as output.

More specifically, AE may include an input layer, at least one hidden layer, and an output layer.

Since the number of nodes in the hidden layer is smaller than the number of nodes in the input layer, the dimensionality of data is reduced, thus leading to data compression or encoding.

Furthermore, the data outputted from the hidden layer may be inputted to the output layer. Given that the number of nodes in the output layer is greater than the number of nodes in the hidden layer, the dimensionality of the data increases, thus leading to data decompression or decoding.

Furthermore, in the AE, the inputted data is represented as hidden layer data as interneuron connection strengths are adjusted through training. The fact that when representing information, the hidden layer is able to reconstruct the inputted data as output by using fewer neurons than the input layer may indicate that the hidden layer has discovered a hidden pattern in the inputted data and is using the discovered hidden pattern to represent the information.

Semi-supervised learning is machine learning method that makes use of both labeled training data and unlabeled training data.

One semi-supervised learning technique involves reasoning the label of unlabeled training data, and then using this reasoned label for learning. This technique may be used advantageously when the cost associated with the labeling process is high.

Reinforcement learning may be based on a theory that given the condition under which a reinforcement learning agent can determine what action to choose at each time instance, the agent can find an optimal path to a solution solely based on experience without reference to data.

Reinforcement learning may be performed mainly through a Markov decision process.

Markov decision process consists of four stages: first, an agent is given a condition containing information required for performing a next action; second, how the agent behaves in the condition is defined; third, which actions the agent should choose to get rewards and which actions to choose to get penalties are defined; and fourth, the agent iterates until future reward is maximized, thereby deriving an optimal policy.

An artificial neural network is characterized by features of its model, the features including an activation function, a loss function or cost function, a learning algorithm, an optimization algorithm, and so forth. Also, the hyperparameters are set before learning, and model parameters can be set through learning to specify the architecture of the artificial neural network.

For instance, the structure of an artificial neural network may be determined by a number of factors, including the number of hidden layers, the number of hidden nodes included in each hidden layer, input feature vectors, target feature vectors, and so forth.

Hyperparameters may include various parameters which need to be initially set for learning, much like the initial values of model parameters. Also, the model parameters may include various parameters sought to be determined through learning.

For instance, the hyperparameters may include initial values of weights and biases between nodes, mini-batch size, iteration number, learning rate, and so forth. Furthermore, the model parameters may include a weight between nodes, a bias between nodes, and so forth.

Loss function may be used as an index (reference) in determining an optimal model parameter during the learning process of an artificial neural network. Learning in the artificial neural network involves a process of adjusting model parameters so as to reduce the loss function, and the purpose of learning may be to determine the model parameters that minimize the loss function.

Loss functions typically use means squared error (MSE) or cross entropy error (CEE), but the present disclosure is not limited thereto.

Cross-entropy error may be used when a true label is one-hot encoded. One-hot encoding may include an encoding method in which among given neurons, only those corresponding to a target answer are given 1 as a true label value, while those neurons that do not correspond to the target answer are given 0 as a true label value.

In machine learning or deep learning, learning optimization algorithms may be deployed to minimize a cost function, and examples of such learning optimization algorithms include gradient descent (GD), stochastic gradient descent (SGD), momentum, Nesterov accelerate gradient (NAG), Adagrad, AdaDelta, RMSProp, Adam, and Nadam.

GD includes a method that adjusts model parameters in a direction that decreases the output of a cost function by using a current slope of the cost function.

The direction in which the model parameters are to be adjusted may be referred to as a step direction, and a size by which the model parameters are to be adjusted may be referred to as a step size.

Here, the step size may mean a learning rate.

GD obtains a slope of the cost function through use of partial differential equations, using each of model parameters, and updates the model parameters by adjusting the model parameters by a learning rate in the direction of the slope.

SGD may include a method that separates the training dataset into mini batches, and by performing gradient descent for each of these mini batches, increases the frequency of gradient descent.

Adagrad, AdaDelta and RMSProp may include methods that increase optimization accuracy in SGD by adjusting the step size and may also include methods that increase optimization accuracy in SGD by adjusting the momentum and step direction. Adam may include a method that combines momentum and RMSProp and increases optimization accuracy in SGD by adjusting the step size and step direction. Nadam may include a method that combines NAG and RMSProp and increases optimization accuracy by adjusting the step size and step direction.

Learning rate and accuracy of an artificial neural network rely not only on the structure and learning optimization algorithms of the artificial neural network but also on the hyperparameters thereof. Therefore, in order to obtain a good learning model, it is important to choose a proper structure and learning algorithms for the artificial neural network, but also to choose proper hyperparameters.

In general, the artificial neural network is first trained by experimentally setting hyperparameters to various values, and based on the results of training, the hyperparameters can be set to optimal values that provide a stable learning rate and accuracy.

The super resolution models 130 to which the artificial intelligence technology as described above is applied may be first generated by the training computing system 300 through a training step, stored in the server computing system 200, and transmitted to the user terminal 100 through the network 400.

The super resolution models 130 may be neural networks for image processing and may be learning models trained to process an image to output a high-resolution image when a low-resolution image is input.

Typically, the super resolution models 130 may be stored in the user terminal 100 in a state where they may be applied to a low resolution image after completing a training step in the training computing system 300, but in some embodiments, the super resolution models may be additionally updated or upgraded through the training even in the user terminal 100.

Meanwhile, the super resolution models 130 stored in the user terminal 100 may be some of the super resolution models 130 generated in the training computing system 300, and new super resolution models may be generated by training computing system 300 if necessary and transmitted to the user terminal 100.

As another example, the super resolution models 130 may be stored in the server computing system 200 instead of being stored in the user terminal 100 and may provide functions required for the user terminal 100 in the form of a web service.

The server computing system 200 includes processors 210 and memory 220 and may generally have greater processing power and greater memory capacity than the user terminal 100. Thus, depending on the system implementation, heavy super resolution models 230 that require more processing power for application may be configured to be stored in the server computing system 200, and lightweight super resolution models 130 that require less processing power for application may be configured to be stored in the user terminal 100.

The user terminal 100 may select a super resolution model suitable for an attribute of an image to be processed among various super resolution models 130. In one example, the user terminal 100 may be configured to use the super resolution model 130 stored in the user terminal 100 when the lightweight super resolution model 130 is required and may be configured to use the super resolution model 230 stored in the server computing system 200 when the heavy super resolution model 230 is required.

The super resolution models 130 and 230 included in the user terminal 100 or the server computing system 200 may be neural networks for image processing generated by the training computing system 300.

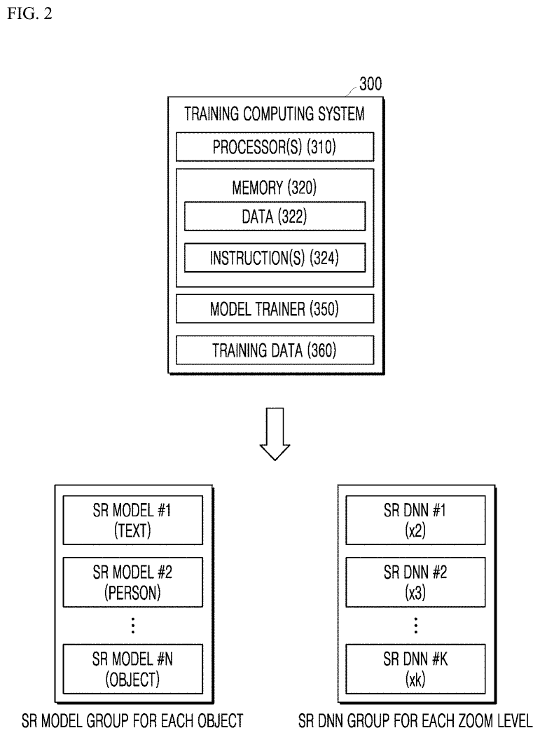

FIG. 2 is a diagram illustrating a system for generating a neural network for image processing according to an embodiment of the present disclosure.

The training computing system 300 may include one or more processors 310 and a memory 320. In addition, the training computing system 300 may also include a model trainer 350 and training data 360 for training machine learning models.

The training computing system 300 may generate a plurality of super resolution models based on the training data 360 via the model trainer 350.

If the training data 360 are a low-resolution image of a person labeled with a high resolution image of the person, the training computing system 300 may generate a super resolution model that can optimally enhance the resolution of the person's image.

Similarly, if the training data 360 are a low-resolution image of text labeled with a high resolution image of the text, the training computing system 300 may generate a super resolution model that can optimally enhance the resolution of the text's image.

In addition, if the training data 360 are a low resolution image of a logo labeled with a high resolution image of the logo, the training computing system 300 may generate a super resolution model and a neural network for image processing that can optimally enhance the resolution of the logo's image.

Furthermore, the training computing system 300 may generate a neural network for image processing that can perform the same type of training on various types of objects such as a human face image, an animal image, and a car image, and may optimally improve images of the type of objects.

In the above manner, the training computing system 300 may generate a super resolution model group according to object. Such a super resolution model group may include super resolution models specialized for improving the resolution of various object images, such as a super resolution model for text, a super resolution model for a person, and a super resolution model for a logo.

In addition, the training computing system 300 may generate a super resolution DNN that may be suitably used in each case where an image is enlarged two times, three times, and four times.

When a low-resolution image is being displayed on the entire screen, when the low resolution image is enlarged two times, only ½ of the corresponding image is displayed on the screen. If the low-resolution image is enlarged three times, only one third of the image is displayed on the screen, and if the low resolution image is enlarged four times, only one quarter of the image is displayed on the screen.

In other words, as the zoom level increases, the number of pixels to be processed and the capacity of the image decrease. Therefore, if the same image processing algorithm is applied, the image processing time of the super resolution model is shorter when the image is enlarged four times than when the image is enlarged two times. On the other hand, compared to the case where the image is enlarged two times, in the case where the image is enlarged fourth times, the input image capacity becomes smaller, and thus the difficulty of the resolution enhancement task becomes higher. Accordingly, if the same image processing algorithm is applied, the quality of the output image result may be lower in the case where the image is enlarged four times, compared to the case where the image is enlarged two times.

Therefore, in order to acquire the best images for each zoom level, it may be preferable to apply a neural network for image processing having higher complexity as the zoom level increases. For example, when the image is enlarged two times, a neural network for image processing in which a hidden layer is formed of two layers may be used, but when the image is enlarged four times, a neural network for image processing in which a hidden layer is formed of four layers may be used.

Depending on the initial configuration of the neural network, the training computing system 300 may generate a neural network for image processing having higher complexity that takes a longer processing time but provides more improved performance and may generate a neural network for image processing having lower complexity that provides lower performance but takes a shorter processing time.

As such, a super resolution model group according to zoom level including super resolution models having various complexity that may be used at various zoom levels may be formed.

Here, the complexity of the neural network for image processing is determined by the number of input nodes, the number of features, the number of channels, the number of hidden layers, and the like. It can be understood that the larger the number of features, the larger the number of channels, and the larger the number of hidden layers, the higher the complexity. Also, it may be referred that the larger the number of channels and the larger the number of hidden layers, the heavier the neural network. In addition, the complexity of the neural network may be referred to as dimensionality of the neural network.

The higher the complexity of the neural network, the better the image resolution performance but the longer it takes to process the image. On the contrary, the lighter the neural network, the relatively lower the image resolution performance but the shorter it takes to process the image.

In addition, the training computing system 300 may generate a plurality of neural networks for image processing having different complexity for each object. For example, the training computing system 300 may generate, as neural networks for image processing trained to enhance a resolution of a person image, a super resolution model group for processing a person image that includes a neural network for image processing optimally trained when a zoom level is ½×, a neural network for image processing optimally trained when a zoom level is 2×, a neural network for image processing optimally trained when a zoom level is 3×, and the like.

As another example, the training computing system 300 may generate, as neural networks for image processing trained to enhance a resolution of an image including a logo, a super resolution model group for processing a logo image that includes a neural network for image processing optimally trained when a zoom level is ½×, a neural network for image processing optimally trained when a zoom level is 2×, a neural network for image processing optimally trained when a zoom level is 3×, and the like.

As another example, the training computing system 300 may generate, as neural networks for image processing trained to enhance a resolution of an image including text, a super resolution model group for processing a text image that includes a neural network for image processing optimally trained when a zoom level is ½×, a neural network for image processing optimally trained when a zoom level is 2×, a neural network for image processing optimally trained when a zoom level is 3×, and the like.

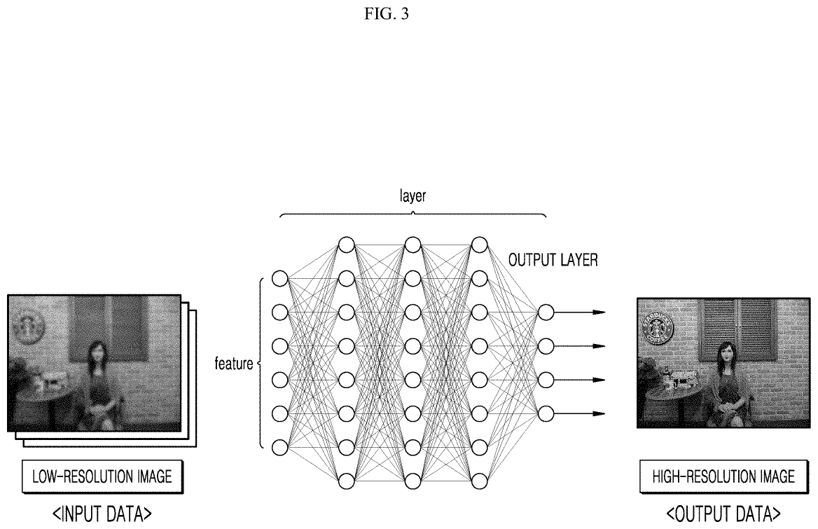

FIG. 3 is a diagram for describing a neural network for image processing according to an embodiment of the present disclosure.

The neural network for image processing may include an input layer, a hidden layer, and an output layer. The number of input nodes is determined according to the number of features, and as the number of nodes increases, the complexity or dimensionality of the neural network increases. In addition, as the number of hidden layers increases, the complexity or dimensionality of the neural network increases.

The number of features, the number of input nodes, the number of hidden layers, and the number of nodes in each layer may be determined by a neural network designer, and as the complexity increases, the processing time takes longer but the performance may be better.

Once the initial neural network structure is designed, the neural network may be trained with training data. To implement the neural network to enhance the image resolution, a high-resolution original image and a low-resolution version of the image are required. By collecting the high-resolution original images, blurring the images, and performing downsampling, the low-resolution images corresponding to the high-resolution original images may be prepared.

Training data that may train a neural network for enhancing image resolution may be prepared by labeling the high-resolution original images corresponding to these low-resolution images.

Training a neural network with a large amount of training data by a supervised learning method may generate a neural network model for image processing that can output the high-resolution image when the low-resolution image is input.

Here, by using the training data including person images as the training data, the neural network for image processing optimized for enhancing the resolution of the person image may be acquired, and by using the training data including logo images as the training data, the neural network for image processing optimized for enhancing the resolution of the logo image may be acquired.

In the same way, by training the neural network with the training data including images of a specific object such as a human face, text, or an animal can obtain the neural network for image processing optimized for enhancing the resolution of the image of the object.

Meanwhile, the processing speed and processing performance of the neural network for image processing may be in a trade-off relationship. A designer may determine whether to enhance the processing speed or the processing performance by changing the initial structure of the neural network.

The designer may set the structure of the neural network in consideration of the number of pixels input according to the zoom level of the image and may train the neural network. Accordingly, the neural network for image processing which may be optimally used according to each zoom level may be acquired.

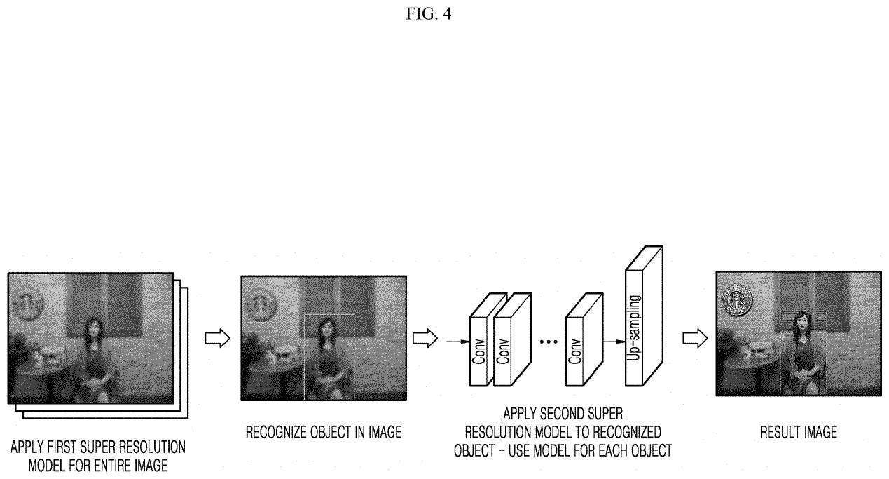

FIG. 4 is a diagram for describing a method for enhancing image resolution according to an embodiment of the present disclosure.

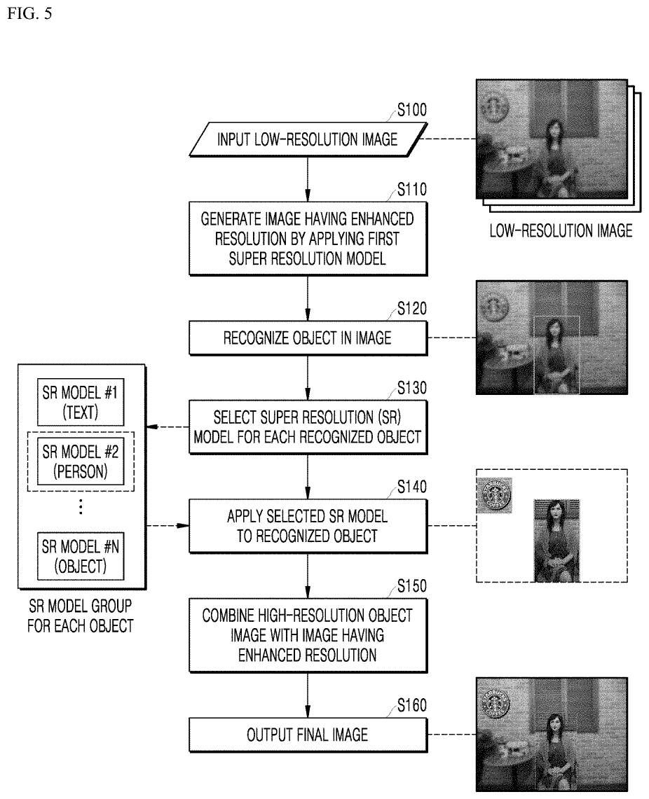

In addition, FIG. 5 is a flowchart for describing a method for enhancing image resolution for each object according to the embodiment of the present disclosure described in FIG. 4.

First, the low-resolution image may be input to an apparatus for enhancing image resolution (S100). The image may be photographed by a device equipped with a camera or may be an image received through wired or wireless communication from an external device. The apparatus for enhancing an image may be a general user terminal such as a computer, a smartphone, and a tablet, and may be a server that performs image resolution enhancement for receiving and improving an image.

The input image may be a single frame image or a multi-frame image. In the case where the multi-frame image is input, when an image area is processed to enhance resolution, the multi-frame image may be input to the super resolution model and used to obtain the high-resolution image.

Compared to the case where the single frame image is used, in the case where the multi-frame image is used, more reference images for image processing are provided, thereby acquiring a high-resolution image having more enhanced quality.

The images proposed as examples in FIGS. 4 and 5 include women and logos of certain cafes and have a low resolution, so that the images may appear somewhat blurred and the women and logos may be difficult to be clearly identified.

A processor of the apparatus for enhancing image resolution may apply a primary super resolution model to the entire image in order to increase identification power of an object prior to identifying the object in the low-resolution image (S110). The primary super resolution model may be a lightweight neural network for image processing for rapid processing.

Herein, the step of enhancing the resolution of the entire image through the lightweight primary super resolution model may be omitted according to an embodiment, and the following object recognition and processing image area selecting step may be immediately performed.

The processor of the apparatus for enhancing image resolution applies the primary super resolution model to perform object recognition on an image having enhanced resolution. A neural network for object recognition can be formed using various models, such as a convolutional neural network (CNN), a fully convolutional neural network (FCNN), a region-based convolutional neural network (R-CNN), and You Only Look Once (YOLO).

The processor of the apparatus for enhancing image resolution may recognize the object in the image by applying the neural network for object recognition to the low-resolution image. In the examples of FIGS. 4 and 5, a woman in the center of the image and the logo on the upper left of the image may be recognized using the neural network for object recognition. The processor may select, as the image processing area, the area in the center of the image where a woman is placed and the area on the upper left of the image where the logo is disposed, according to the position of the recognized object.

That is, the processor may identify an object included in the image through the neural network for object recognition, select the image area including the identified object, and then determine the attribute of the selected image area according to the type of the identified objects. In the examples of FIGS. 4 and 5, the processor may identify the woman and the logo included in the image through the neural network for object recognition, select the image area including the identified woman and the image area including the logo, and then determine the attribute of the area including the woman image as a person and the attribute including the logo image as a logo.

Here, various types of objects that can be identified through the neural network for object recognition may include a person, a logo, text, an animal, a human face and the like, and the attribute of the image area may be determined according to the type of the identified objects.

As will be described in more detail below, the attribute of the image area to be processed includes the zoom level at which the image area to be processed is enlarged or reduced, or the pixel or resolution of the image area to be processed, and the like, in addition to the type of object to be identified.

The processor may select a super resolution model suitable for the recognized object from the super resolution model groups according to object based on the fact that the recognized image is a person (S130). The super resolution model group according to object may include a super resolution model for text, a super resolution model for a person, and the like.

The processor may select a super resolution model trained to be suitable for a person image for a woman on the center of the image and apply the super resolution model for a person to the image including the recognized object.

In addition, the processor may recognize the logo on the upper left of the image having the enhanced resolution by the first super resolution model and select the super resolution model for enhancing the resolution of the logo (S130).

The processor may apply the selected super resolution model to the recognized objects (S140). The processor may apply the super resolution model for a person to the woman on the center of the image and the super resolution model for a logo to the logo on the upper left of the image.

Compared to the case of applying the same super resolution model to the entire image, an effect of implement higher resolution can be achieved by applying the super resolution model trained to the attributes of each image.

The super resolution models trained according to the types of the objects are each applied to the recognized objects, respectively, and the high-resolution images for each object can be obtained. The processor may combine the high-resolution images for each object which are obtained in the way described above and the entire image having the enhanced resolution to which the primary resolution model is applied (S150).

The processor may output the final image by combining the high-resolution images for each object and the entire image having the enhanced resolution (S160). The output may be through a display of the apparatus for enhancing image resolution or through transmission to another device having a display.

In general, the information that the user wants to acquire from the image is often information on the object in the image. Therefore, as described above, the method for enhancing resolution around an object in an image may more efficiently process an image than the case of enhancing the entire image while meeting the user's need.

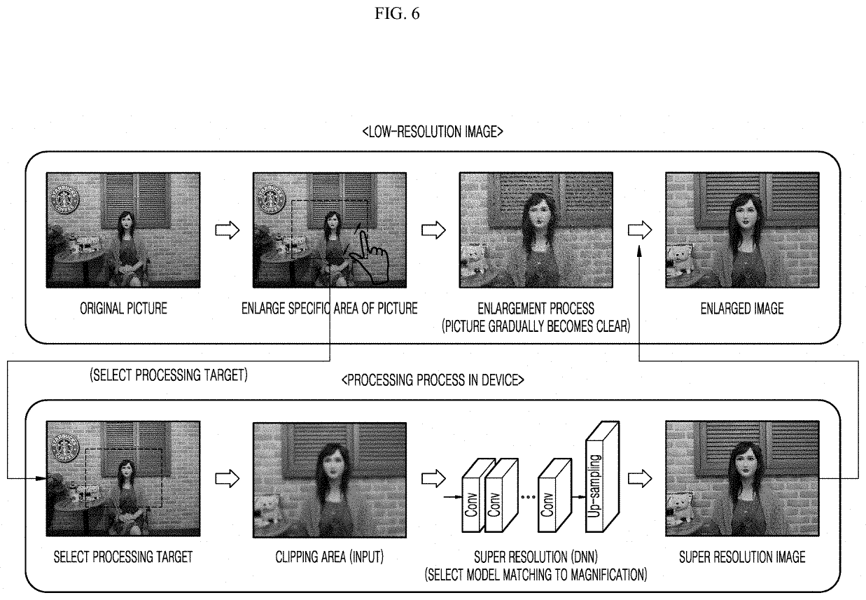

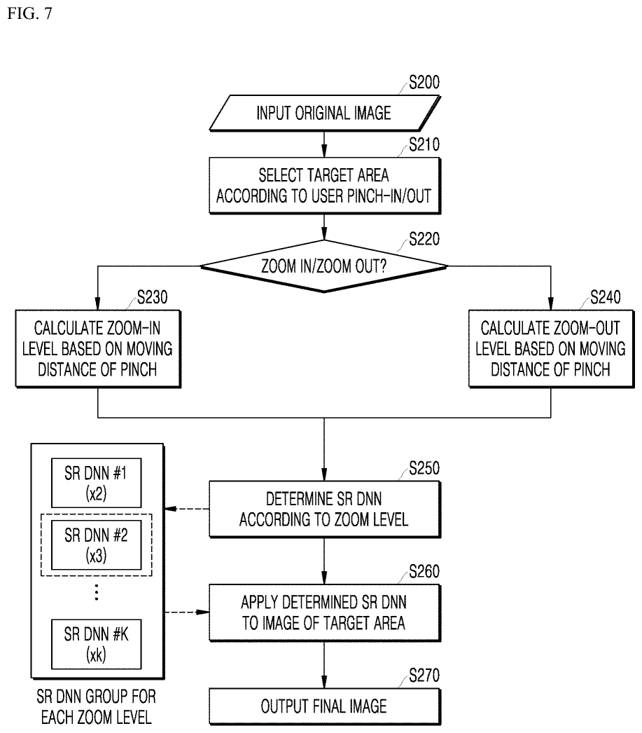

FIG. 6 is a diagram for describing a process of performing, by a user terminal, a method for enhancing image resolution according to an embodiment of the present disclosure. In addition, FIG. 7 is a flowchart for describing a method for enhancing image resolution for each zoom level according to the embodiment of the present disclosure described in FIG. 6.

Referring to FIG. 6, a low-resolution original image to be processed may be input to a user terminal screen (S200). The processor of the apparatus for enhancing image resolution may receive a user's enlargement or reduction instruction for the low-resolution image. For example, when a user's finger touches an image display to perform pinch-in/out, an enlargement or reduction instruction may be transmitted, so an image area to be displayed may be selected (S210).

In terms of the processing process inside the device, when an area to be enlarged and displayed is selected as shown in FIG. 6, a process of clipping the area may be performed.

The processor may calculate the zoom-in/zoom-out level by a moving distance of a pinch depending on whether an enlargement instruction is received (that is, whether zoom-in needs to be performed) or whether a reduction instruction is received (that is, whether zoom-out needs to be performed) (S230 and S240).

Here, as the expression representing the zoom-in/zoom-out level, the enlargement or reduction magnification may be used. When the image is enlarged two times, the enlargement or reduction magnification is expressed as two times, and when the image is reduced to ½, the enlargement or reduction magnification is expressed as ½ times.

As illustrated in FIG. 6, an enlargement instruction is received for a specific area of an input image, and the corresponding area may be enlarged and displayed. The processor may determine the attribute of the image of the displayed area according to the zoom level.

For example, when the original image is enlarged to a magnification of two times, the attribute of the image area selected as an area to be displayed may be determined as a zoom level of two times (2×), and when the original image is reduced to a magnification of ½ times, the attribute of the image area selected as an area to be displayed may be determined as a zoom level of ½ times (½×). In another way, the processor may determine, as an attribute, the number of pixels or the resolution of the area that is eventually displayed according to zoom in/out.

The processor may determine a super resolution neural network to be used for image processing according to the zoom level (S250). As described above, the training computing system 300 may generate a super resolution neural network group according to zoom level which includes neural networks that are trained to optimally enhance resolution in processing time and processing performance for each zoom level. Here, the super resolution neural network is used in the same sense as the super resolution model and the neural network for image processing in the function of enhancing the image resolution, but is a term used to identify the neural network trained according to the zoom level.

As illustrated in FIG. 6, when the image is enlarged, a suitable super resolution neural network may be selected according to the enlargement magnification. For example, if the image is enlarged two times, the processor can select the optimally trained super resolution neural network when the zoom magnification is two times.

Here, as the zoom magnification increases, the number of pixels to be processed decreases, and therefore a super resolution neural network having higher complexity which is designed to focus on the processing performance rather than the processing time may be selected.

On the other hand, as the zoom magnification decreases, the number of pixels to be processed increases, and therefore a super resolution neural network having lower complexity which is designed to focus on the processing time rather than the processing performance may be selected.

When the super resolution neural network to be used is determined, the processor may apply the determined super resolution neural network to the image of the area selected to be displayed (S260). In terms of the processing process inside the device, it can be understood as a process in which an area clipped to be displayed is input to a super resolution neural network determined to match the magnification.

The super resolution neural network may process the received image and output a final high-resolution image (S270). The output may be through a display of an apparatus for enhancing image resolution or through transmission to another device having a display, so the enlarged high-resolution image may be displayed on the display of the user terminal.

The above-described image processing may be performed inside the user terminal. Alternatively, the user terminal may only transmit and receive images according to the processing power of the user terminal, and the image processing through the neural network may be designed to be performed in an external server.

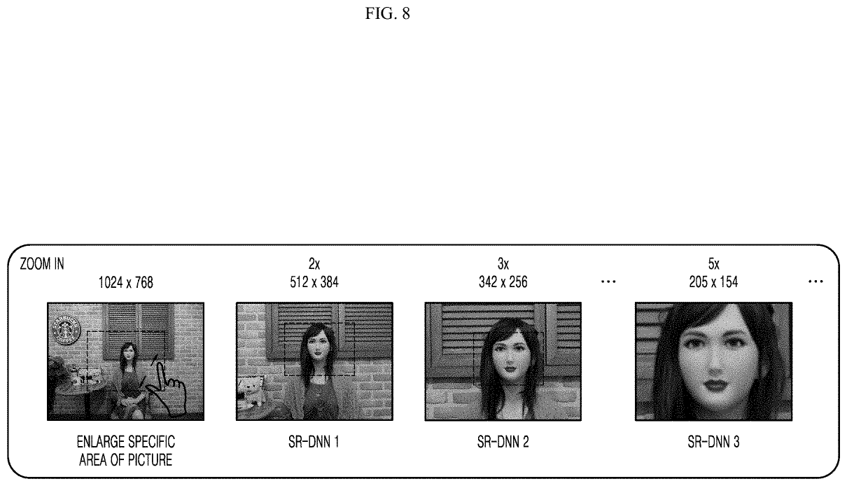

FIG. 8 is a diagram for describing a method for enhancing image resolution in a zoom-in operation according to an embodiment of the present disclosure.

FIG. 8 illustrates a super resolution neural network model selected according to a zoom magnification when zoom-in is made. For example, if the input image has a resolution of 1024×768 and the 2× enlargement is made, then an image having a resolution of 512×384 needs to be processed, so accordingly, a neural network (SR-DNN1) having relatively low complexity among super resolution neural networks may be selected and used.

When 3× enlargement is made according to a user's instruction, an image having a resolution of 342×256 needs to be processed, and since the capacity of the image to be processed decreases, a neural network (SR-DNN2) having higher complexity among the super resolution neural networks can be selected and used.

When 5× enlargement is made according to a user's instruction, an image having a resolution of 205×154 needs to be processed, and since the capacity of the image to be processed more decreases, a neural network (SR-DNN3) having much higher complexity among the super resolution neural networks can be selected and used.

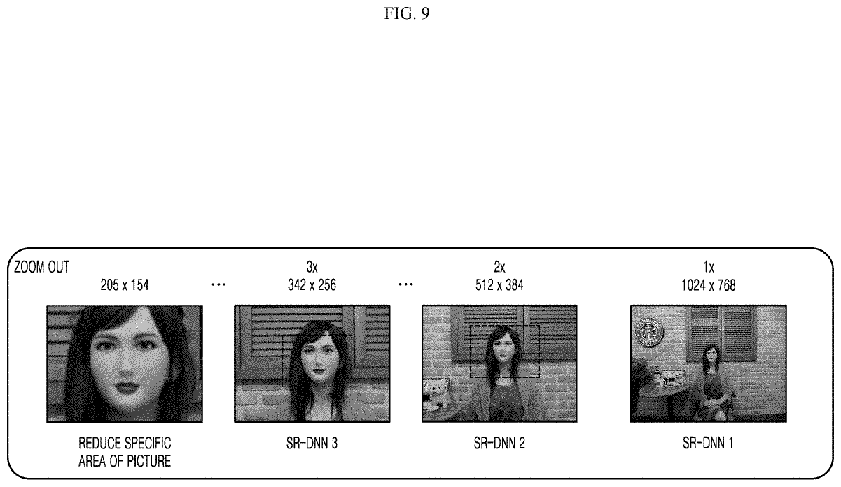

In addition, FIG. 9 is a diagram for describing a method for enhancing image resolution in a zoom-out operation according to an embodiment of the present disclosure.

FIG. 9 illustrates a super resolution neural network model selected according to a zoom magnification when zoom-out is made. For example, it is assumed that the input image is an image having a resolution of 205×154, and a user's reduction instruction is made thereto.

When the reduction to about ⅗× is made according to a user's instruction, an image having a resolution of 342×256 needs to be processed, so a neural network (SR-DNN3/5) having relatively higher complexity among the super resolution neural networks can be selected and used according to the capacity of the image to be processed.

When the reduction to about ⅖× is made according to a user's instruction, an image having a resolution of 512×394 needs to be processed, and since the capacity of the image to be processed more increases, a neural network (SR-DNN2/5) having relatively lower complexity among the super resolution neural networks can be selected and used.

When the reduction to about ⅕× is made according to a user's instruction, an image having a resolution of 1024×768 needs to be processed, so a neural network (SR-DNN1/5) having relatively much lower complexity among the super resolution neural networks can be selected and used.

In other words, as the zoom magnification increases, the neural network for image processing having higher complexity may be adopted with a focus on the processing performance rather than the processing time, and as the zoom magnification decreases, the neural network for image processing having lower complexity may be adopted with a focus on the processing time rather than the processing performance.

In this way, by using the neural networks for image processing differentiated according to the attributes of the image, the zoom level, or the pixels of the area selected to be displayed or image capacities, the optimized resolution enhancement in the processing time and the processing performance can be achieved.

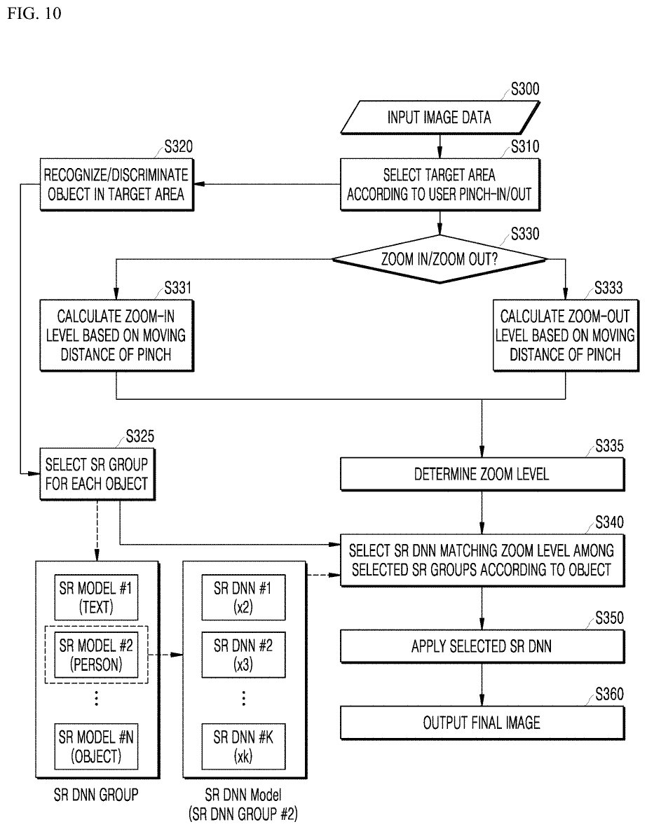

FIG. 10 is a flowchart for describing a method for enhancing image resolution according to an embodiment of the present disclosure.

FIG. 10 illustrates a case where the neural network for image processing is selected in consideration of the type of objects according to the identification of the objects in the image in addition to the zoom-in/zoom-out.

First, the apparatus for enhancing image resolution may receive image data (S300). The input image may be an image photographed by a camera installed in the apparatus for enhancing image resolution or an image received from an external device through wired or wireless communication.

A processor of the apparatus for enhancing image resolution may select an area to be displayed by an enlargement or reduction instruction according to user pinch-in/out (S310). When the area to be displayed is selected, the processor may recognize an object in the area to be displayed and discriminate the type of objects.

For example, when the image is enlarged and only a woman is displayed as shown in FIG. 6, the processor may recognize that an image of a woman is included in the image through the neural network for object identification.

Accordingly, the processor may select a super resolution model specialized to enhance a resolution of a person image from the super resolution DNN group including the super resolution models for each type of object (S325). Meanwhile, the selected super resolution model may include super resolution neural networks according to the zoom level.

The processor may also calculate the zoom-in/zoom-out level according to the moving distance of the pinch according to the zoom-in/zoom-out (S331 and S333) and determine the zoom level (S335).

For example, if the zoom level is determined to be an enlargement of 2×, the processor may select a super resolution neural network suitably trained when the zoom level is enlarged to 2× among super resolution neural networks included in a super resolution model for a person (S340). Here, the selection criterion of the neural network may be the capacity or resolution of an image to be processed according to the zoom level.

As described above, the processor may select a super resolution neural network matching the zoom level among the selected super resolution model groups according to the object.

When the super resolution neural network to be applied to the target image for enhancing the resolution is determined, the processor may apply the neural network to the target image (S350). According to this embodiment, the processor may input a woman image enlarged two times to a super resolution neural network that is for a person and is trained to 2×.

As a result, the final high-resolution image of the woman image enlarged two times according to the processing of the super resolution neural network may be output (S360).

By dynamically selecting and utilizing the optimized neural network for image processing according to an object and a zoom level or a resolution of an image as described above, the embodiments of the present disclosure can efficiently and effectively enhance the image resolution.

Meanwhile, the user may further refine the learning model by continuously giving feedback on the determination result of the neural network model for image processing.

Embodiments according to the present disclosure described above may be implemented in the form of a computer program that can be executed through various components on a computer, and such a computer program may be recorded in a computer-readable medium. Examples of the computer-readable media include, but are not limited to: magnetic media such as hard disks, floppy disks, and magnetic tape; optical media such as CD-ROM disks and DVD-ROM disks; magneto-optical media such as floptical disks; and hardware devices that are specially configured to store and execute program codes, such as ROM, RAM, and flash memory devices.

Meanwhile, the computer programs may be those specially designed and constructed for the purposes of the present disclosure or they may be of the kind well known and available to those skilled in the computer software arts. Examples of computer programs may include both machine codes, such as produced by a compiler, and higher-level codes that may be executed by the computer using an interpreter.

As used in the present disclosure (especially in the appended claims), the singular forms “a,” “an,” and “the” include both singular and plural references, unless the context clearly states otherwise. Also, it should be understood that any numerical range recited herein is intended to include all sub-ranges subsumed therein (unless expressly indicated otherwise) and accordingly, the disclosed numeral ranges include every individual value between the minimum and maximum values of the numeral ranges.

The order of individual steps in process claims according to the present disclosure does not imply that the steps must be performed in this order; rather, the steps may be performed in any suitable order, unless expressly indicated otherwise. The present disclosure is not necessarily limited to the order of operations given in the description. All examples described herein or the terms indicative thereof (“for example,” “such as”) used herein are merely to describe the present disclosure in greater detail. Therefore, it should be understood that the scope of the present disclosure is not limited to the example embodiments described above or by the use of such terms unless limited by the appended claims. Also, it should be apparent to those skilled in the art that various modifications, combinations, and alternations can be made depending on design conditions and factors within the scope of the appended claims or equivalents thereof.

It should be apparent to those skilled in the art that various substitutions, changes and modifications which are not exemplified herein but are still within the spirit and scope of the present disclosure may be made.

What is claimed is:

1. A method for enhancing image resolution, the method comprising:
receiving a low-resolution image;
selecting an image processing area for the low-resolution image;
selecting a neural network for image processing according to an attribute of the selected image processing area among neural network groups for image processing; and
generating a high-resolution image for the selected image processing area by processing the selected image processing area according to the selected neural network for image processing.

2. The method of claim 1, wherein the selecting an image processing area includes:
identifying an object included in the low-resolution image through a neural network for object recognition;
selecting an image area including the identified object; and
determining an attribute of the selected image area according to a type of the identified object.

3. The method of claim 2, wherein the type of the object is at least one of a person, text, and a logo,
wherein the neural network group for image processing includes at least one of a neural network trained to enhance a resolution of a person image, a neural network trained to enhance a resolution of a text image, and a neural network trained to enhance a resolution of a logo image, and
wherein the selecting of the neural network for image processing includes selecting a neural network for image processing suitable for the type of the identified object among the neural network groups for image processing.

4. The method of claim 1, wherein the selecting of the image processing area includes:
receiving a screen enlargement or reduction instruction from a user;
selecting an image area to be displayed according to the screen enlargement or reduction instruction; and
determining the attribute of the selected image area according to the screen enlargement or reduction magnification, and
wherein the selecting of the neural network for image processing includes selecting a neural network for image processing having higher complexity among the neural network groups for image processing as a zoom magnification according to the screen enlargement or reduction instruction increases.

5. The method of claim 1, wherein the selecting of the image processing area includes receiving a screen enlargement or reduction instruction from a user,
wherein the selecting of the neural network for image processing includes selecting a first neural network from the neural network group for image processing in response to receiving the enlargement instruction from the user, or selecting a second neural network from the neural network group for image processing in response to receiving the reduction instruction from the user, and
wherein complexity of the first neural network is higher than that of the second neural network.

6. The method of claim 1, wherein the low-resolution image is a multi-frame image, and
wherein the processing of the selected image processing area includes obtaining a high-resolution image through the selected neural network for image processing by using a multi-frame image as an input.

7. The method of claim 1, further comprising:
after the generating of the high-resolution image, generating a synthesis image by synthesizing the low-resolution image with the high-resolution image for the image processing area.

8. A method for enhancing image resolution, the method comprising:
receiving a low-resolution image;
receiving an enlargement or reduction instruction from a user;
selecting an area to be displayed in the low-resolution image according to the enlargement or reduction instruction; and
selecting a first neural network for image processing according to the enlargement or reduction instruction and applying the first neural network for image processing to an image of the area to be displayed.

9. The method of claim 8, further comprising:
after the selecting of the area to be displayed,
identifying an object within the image of the area to be displayed by using a neural network for object identification;
selecting a second neural network for image processing according to a type of the identified object and applying the second neural network for image processing to an image including the object; and
generating a high-resolution image of the image including the object through the second neural network for image processing.

10. The method of claim 8, further comprising:
after the receiving of the low-resolution image, generating an image having enhanced resolution by applying a third neural network for image processing to the low-resolution image, and
wherein the applying of the third neural network includes applying the first neural network for image processing to the enhanced image.

11. The method of claim 9, further comprising:
after the generating of a high-resolution image of the object, generating a synthesis image by synthesizing the enhanced image with the high-resolution image for the object.

12. The method of claim 9, wherein the second neural network for image processing is a neural network for image processing trained to enhance a resolution of an image belonging to the type of the object.

13. The method of claim 12, wherein the second neural network for image processing is a neural network trained with training data including a plurality of low-resolution images belonging to the type of the object as input data and high-resolution images corresponding to the low resolution images as a label.

14. The method of claim 8, wherein the applying of the first neural network includes selecting a neural network for image processing having high complexity as the first neural network for image processing as a zoom magnification according to the enlargement or reduction instruction increases.

15. The method of claim 8, wherein the receiving of the enlargement or reduction instruction from the user includes receiving the enlargement or reduction instruction according to a pinch movement of the user, and
wherein the applying of the first neural network includes selecting the first neural network for image processing based on a moving distance and direction of the pinch movement,
wherein when the direction of the pinch movement is a pinch-in direction, the neural network for image processing having high complexity is selected as the first neural network for image processing as the moving distance increases, and
wherein when the direction of the pinch movement is a pinch-out direction, the neural network for image processing having low complexity is selected as the first neural network for image processing as the moving distance increases.

16. The method of claim 8, further comprising:
after the selecting of the area to be displayed and before the applying of the first neural network,
identifying an object within the image of the area to be displayed by using a neural network for object identification; and
selecting a neural network group for image processing suitable for a type of the object according to the type of the identified object, and
wherein the first neural network for image processing is one of the neural networks for image processing belonging to the neural network group for image processing.

17. A non-transitory computer-readable recording medium having stored thereon a computer program, when executed by a computer, the computer program configured to cause the computer to execute the method of claim 1 when executed by the computer.

18. An apparatus for enhancing image resolution, the apparatus comprising:
a processor; and
a memory connected to the processor,
when executed by the processor, the memory configured to store instructions to cause the processor to:
receive a low-resolution image,
receive an enlargement or reduction instruction from a user,
select an area to be displayed in the low-resolution image according to the enlargement or reduction instruction, and
select a first neural network for image processing according to the enlargement or reduction instruction and apply the first neural network for image processing to an image of the area to be displayed.

19. The apparatus of claim 18, wherein the instructions cause the processor to:
identify an object in the image of the area to be displayed using a neural network for object identification,
select a second neural network for image processing according to a type of the identified object and apply the second neural network for image processing to an image including the object, and
generate a high-resolution image of the image including the object through the second neural network for image processing.

20. The apparatus of claim 18, wherein the instructions cause the processor to:
identify the object in the image of the area to be displayed using a neural network for object identification,
select a neural network group for image processing suitable for a type of the object according to the type of the identified object, and
select one of neural networks for image processing belonging to the neural network group for image processing as the first neural network for image processing according to the enlargement or reduction instruction.
